(19) United States
(12) Patent Application Publication
(10) Pub. No.: US 2008/0129628 A1
(43) Pub. Date: Jun. 5, 2008

(54) WIDEBAND ANTENNA FOR MOBILE DEVICES

(76) Inventors: Kent Rosengren, Kalmar (SE); Hakan Karlsson, Kalmar (SE)

Correspondence Address: MARSH, FISCHMANN & BREYFOGLE LLP, 3151 SOUTH VAUGHN WAY, SUITE 411, AURORA, CO, 80014, US

(21) Appl. No.: 11/565,906

(22) Filed: Dec. 1, 2006

(51) Int. Cl. H01Q 15/08

(52) U.S. Cl. 343/785

(57) ABSTRACT

A dielectric based antenna provides for relatively wide band communications. In this regard, the dielectric based antenna may provide communications across a variety of mobile telephone communication types and frequencies, such as GSM850, EGSM900, DCS1800, PCS1900, and UMTS. In one embodiment, the dielectric based antenna includes a dielectric element and at least first and second antenna elements. The dielectric element may be configured into a volumetric shape from a material with a relatively high permittivity. The first and second antenna elements are respectively wrapped about first and second portions of the dielectric element and may provide for respective first and second frequency bands of the dielectric based antenna. An antenna feed port couples the dielectric based antenna to a communication module via an antenna feed such that radio signals may be transmitted and/or received through the dielectric based antenna.

### BACKGROUND

Wireless devices, such as cellular phones and personal digital assistants (PDAs), are often configured to operate within certain predetermined frequency bands. For example, government regulators (e.g., the Federal Communications Commission, or FCC) typically mandate the types of communications and frequency ranges that communication providers (e.g., Verizon, Sprint, Qwest, Cingular, T-Mobile, etc.) can use. Examples of these communication types/frequency ranges include GSM850, EGSM900, DCS1800, PCS1900, and UMTS, each of which is well known to those skilled in the art. Since a communication provider generally does not use every available communication type/frequency range, an electronics manufacturer may desire to configure a wireless device to communicate with one or more of these communication types/frequency ranges to make the device acceptable to a variety of communication providers.

The trend in shrinking device sizes including their antennas, however, presents antenna design problems that conflict with the goals of such wideband communications. To illustrate, one common dual-frequency mobile phone may use GSM900 or GSM1800 for its communications. The resonance frequency of the antenna of such a mobile phone is either 900 MHz or 1800 MHz. As a manufacturer seeks to decrease the size of this mobile phone, the manufacturer routinely seeks to decrease the size of the phone's antenna. Since antenna length is generally inversely proportional to the antenna's frequency capability, lower frequency performance of the antenna can be affected when the antenna length is decreased. Accordingly, configuring a smaller antenna with frequency capabilities of both 900 MHz and 1800 MHz is problematic. Configuring smaller antennas to operate within each of the above mentioned communication types/frequency ranges is even more problematic because closer frequency bands can have signals that interfere with one another. That is, a single antenna that provides a wideband of frequency capabilities without band limiting may allow signals from one communication type/frequency range interfere with signals from another.

One antenna that overcomes some of the antenna length/bandwidth obstacles includes a dielectric antenna, such as a Planar Inverted F-Antenna (PIFA). A dielectric antenna generally embeds a probe into a dielectric material such that the probe may transfer energy to the dielectric material. Alternatively, energy may be transferred to the dielectric material by means of an “aperture feed” proximate to the dielectric material. The energy that is transferred to the dielectric material is radiated from the dielectric material as a radio frequency (RF) signal. In either case, the dielectric antenna generally uses shape and volume of the dielectric material, probe, aperture feed, and ground plane to change the frequency characteristics of the antenna. In this regard, dielectric antennas may achieve some of the frequency traits commonly associated with antenna length computations by the “compacting” of antennas into volumetric shapes. However, these volumetric antenna shapes still add to the overall size of the antenna and, thus, the wireless device employing it, particularly when the antenna is configured to service the wide range of communication type/frequency ranges mentioned above.

The foregoing examples of the related art and limitations related therewith are intended to be illustrative and not exclusive. Other limitations of the related art will become apparent to those of skill in the art upon a reading of the specification and a study of the drawings.

### SUMMARY

The following embodiments and aspects of thereof are described and illustrated in conjunction with systems, tools, and methods which are meant to be exemplary and illustrative, and not limiting in scope. In various embodiments, one or more of the above-described problems have been reduced or eliminated, while other embodiments are directed to other improvements.

In one embodiment, a wireless communication device includes a dielectric based antenna having a dielectric element and at least first and second antenna elements. The first and second antenna elements are respectively wrapped about first and second portions of the dielectric element. The wireless communication device also includes an antenna feed coupled to the dielectric based antenna and a communication module coupled to the antenna feed. The dielectric based antenna may be either a monopole antenna or a dipole antenna. The dielectric based antenna may be operable with a range of radio frequencies from about 800 MHz to about 2200 MHz. For example, the dielectric based antenna may be operable with one or more, or even all of, communication signal types selected from a group consisting of GSM 850, EGSM 900, DCS 1800, PCS 1900, and UMTS.

The first antenna element may have a surface area that is greater than the surface area of the second antenna element. The antenna feed may be galvanically coupled to the second antenna element. The first antenna element may be coupled to the second antenna element via a strip feed. The first antenna element, the second antenna element, and the strip feed may be configured from substantially the same conductive material. For example, the first antenna element, the second antenna element, and the strip feed are configured from a single conductive material, such as copper. Alternatively, the first antenna elements, the second antenna elements, and the strip feed may be configured from separate materials that have the same or similar conductive properties.

The dielectric element may include an aperture that provides an air slot between the first and second antenna elements. The dielectric element may include a material having a high permittivity. For example, the dielectric element may be configured of a ceramic material having a relatively high permittivity.

The wireless communication device may also include an antenna feed port configured proximate to the second antenna element for providing a coaxial coupling to the antenna feed, wherein the antenna feed is a coaxial cable. Alternatively, the wireless communication device may further include an antenna feed port configured proximate to the second antenna element for providing a galvanic coupling to the antenna feed, wherein the antenna feed is a conductive strip. In this regard, the communication module may be a receiver, transmitter, or a transceiver coupled to the antenna feed.

In one embodiment, a dielectric based antenna includes a dielectric element, a conductive antenna element wrapped about at least a portion of the dielectric element, and an antenna feed port galvanically coupled to the conductive antenna element.

In another embodiment, a dielectric based antenna includes a substrate, a ground plane affixed to a first layer of the substrate, and a dielectric element having a first permittivity and a surface. For example, the dielectric element may include a ceramic material having a relatively high permittivity. The dielectric element is mounted on the first layer of a substrate proximate to the ground plane. An antenna module affixed to at least a portion of the surface of the dielectric element and an antenna feed coupled to the antenna module.

The antenna element may be configured for operation with a relatively wide band of radio frequencies. For example, the antenna element may be operable within a range of frequencies of about 800 MHz to about 2200 MHz. In this regard, the antenna module may be operable with one or more, or even all of, communication signal types selected from a group consisting of GSM 850, EGSM 900, DCS 1800, PCS 1900, and UMTS.

The antenna module may include a first antenna element that transmits radio signals within a first band of radio frequencies within the wide band of radio frequencies. The antenna module may include a second antenna element that transmits radio signals within a second band of radio frequencies within the wideband of radio frequencies, wherein the second band of radio frequencies is higher than the first band of radio frequencies. For example, the first antenna element may be affixed to a first portion of the surface of the dielectric element and the second antenna element may be affixed to a second portion of the surface of the dielectric element. The antenna element may also include an air slot configured between the first antenna element and the second antenna element. The antenna element may also include a conductive strip coupling the first antenna element in the second antenna element.

In one embodiment, the antenna module may include at least a first antenna element and a second antenna element. The dielectric based antenna may further include an antenna feed port galvanically coupled to the second antenna element. The antenna feed may be a coaxial cable that couples to the antenna feed port. Alternatively, the antenna feed may be a conductive strip that galvanically couples to the antenna feed port.

In one embodiment, a method of transmitting radio signals includes providing a dielectric based antenna having a first antenna element and a second antenna element wrapped about a dielectric element that configures a frequency range of operability for the dielectric based antenna. The method also includes transmitting a first radio signal at a first frequency within the frequency range of operability. Additionally, the method includes, after transmitting the first radio signal at the first frequency, transmitting a second radio signal at a second frequency within the frequency range of operability, wherein the first frequency differs from the second frequency. The first and second radio signals may be selected from a group consisting of GSM 850, EGSM 900, DCS 1800, PCS 1900, and UMTS.

In addition to the exemplary aspects and embodiments described above, further aspects and embodiments will become apparent by reference to the drawings and by study of the following descriptions.

### BRIEF DESCRIPTION OF THE DRAWINGS

Exemplary embodiments are illustrated in referenced figures of the drawings. It is intended that the embodiments and figures disclosed herein be considered illustrative rather than limiting.

FIG. 1 is an illustration of a dielectric based antenna.

FIG. 2 is an illustration of the dielectric based antenna of FIG. 1 configured with a ground plane.

FIG. 3 is a perspective view of an exemplary dielectric based antenna.

FIG. 4 is an exploded partial view of the dielectric based antenna of FIG. 3.

FIGS. 5 and 6 are graphs illustrating experimentally obtained frequency characteristics of a dielectric based antenna.

FIG. 7 is an exemplary embodiment in which a dielectric based antenna may be configured.

FIG. 8 is a flowchart of a process for transmitting signals using a dielectric based antenna.

FIG. 9 is a perspective view of a dielectric based antenna configured with a coaxial cable.

### DETAILED DESCRIPTION OF THE DRAWINGS

Reference will now be made to the accompanying drawings, which assist in illustrating the various pertinent features of the present invention. Although the present invention will now be described primarily in conjunction with an antenna for portable wireless electronics, it should be expressly understood that the present invention may be applicable to other applications where it is desired to communicate using multiple frequencies and/or communication types. In this regard, the following description of a dielectric based antenna is presented for purposes of illustration and description. Furthermore, the description is not intended to limit the invention to the form disclosed herein. Consequently, variations and modifications commensurate with the following teachings, and skill and knowledge of the relevant art, are within the scope of the present invention. The embodiments described herein are further intended to explain modes known of practicing the invention and to enable others skilled in the art to utilize the invention in such, or other embodiments and with various modifications required by the particular application(s) or use(s) of the present invention.

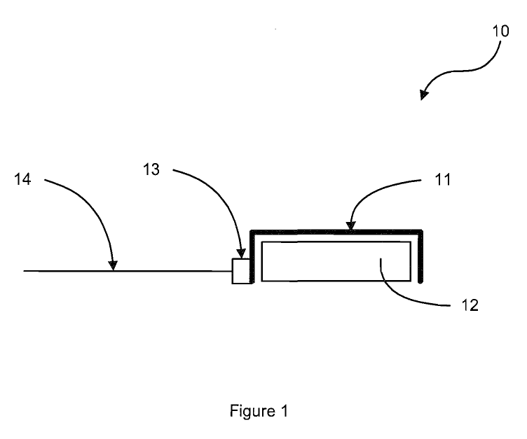

Turning now to FIG. 1, an illustration of a dielectric based antenna 10 is presented. The dielectric based antenna 10 has an antenna element 11 and a dielectric material 12 that may provide resonant frequency characteristics to the antenna element as similarly found in a dielectric loaded antenna (DLA). For example, the dielectric element 12 may be a material having a relatively high permittivity (e.g., a ceramic material) that changes the resonant frequency of the antenna element 11. Additionally, the shape of the dielectric element 12 may contribute to the resonant frequency characteristics of the dielectric based antenna 10. The antenna element 11 is generally “wrapped” about at least a portion of the dielectric element 12 to radiate signals. In this regard, the dielectric element 12 may “load” the dielectric based antenna 10 to configure the frequency radiation characteristics of the antenna element 11. The dielectric element 12 may, therefore, force the antenna element 11 to radiate signals in frequency ranges as determined, at least in part, by physical properties of the dielectric element 11.

Also illustrated with the dielectric based antenna 10 is the antenna feed port 13 and the antenna feed 14. The antenna feed 14 may provide a modulated signal for transmission via the antenna element 11. The antenna feed port 13 is coupled to the antenna feed 14 and is generally configured to feed the modulated signal from antenna feed 14 to the antenna element 11. Generally, the antenna feed port 13 is a galvanic connection (e.g., solder connection) between the antenna element 11 and the antenna feed 14.

The invention, however, should not be construed to only feeding a signal to the antenna element 11 as other embodiments may include feeding to the dielectric element 12 and/or the antenna element 11, based on design considerations (e.g., a requisite frequency of operation for the dielectric based antenna 10). Additionally, the invention is not intended to be limited to only transmitting a signal as other embodiments may include employing the dielectric based antenna 10 for receiving and/or transmitting.

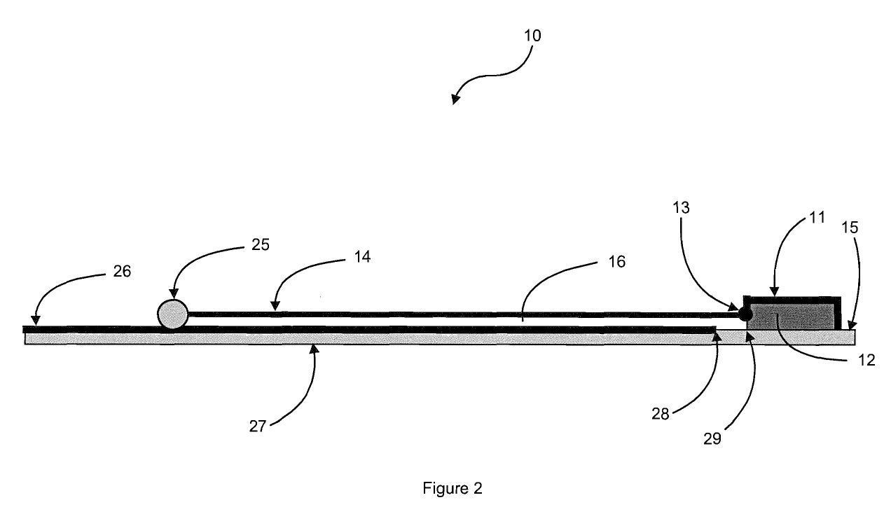

FIG. 2 illustrates a block diagram of the dielectric based antenna 10 of FIG. 1 configured on a substrate 27. For example, the substrate 27 may be a printed circuit board that includes various electronics used in conjunction with an antenna (e.g., receiver electronics, transmitter electronics, etc.). As with many printed circuit boards, the substrate 27 may be configured with a ground plane 26 to supply ground (i.e., zero potential) to various components configured with the substrate 27. The dielectric based antenna 10 may be configured on the substrate 27 at a location distal to the ground plane 26. For example, the dielectric based antenna 10 may be positioned on the same side 15 of the substrate 27 in which the ground plane 26 is layered. The ground plane 26 may be layered upon a substantial portion of the side 15 of the substrate 27. However, the ground plane 26 may cease covering the side 15 of the substrate 27 at the point 28 with the dielectric element 12 being positioned on the side 15 at the point 29 so as to prevent DC interference with the dielectric based antenna 10.

In this embodiment, the dielectric element 12 is configured directly upon the side 15 of the substrate 27 and the antenna element 11 is wrapped thereabout. As shown here, the antenna port 13 is elevated from the substrate 27 such that the antenna feed 14 does not contact the ground plane 26. This is relevant because the antenna feed 14 may be a “strip feed” (e.g., microstrip, printed circuit board trace, etc.) that feeds a modulated signal to the antenna port 13. In this regard, direct connection to the ground plane 26 may similarly cause DC interference with the modulated signal and/or undesirably ground the signal. Accordingly, the dielectric based antenna 10 of this embodiment may be configured with another substrate 16 between the antenna feed 14 and the ground plane 26.

Also shown in this embodiment is the connector 25. The connector 25 provides a connection to the antenna feed 14 for components requiring use thereof. For example, a transmitter may be configured with the substrate 27. To transmit signals from the dielectric based antenna 10, the transmitter may require a connection to the antenna feed 14 via the connector 25. Accordingly, the connector 25 may be configured with respect to the antenna feed 14 providing signals to the antenna feed port 13. That is, the connector 25 may be a galvanic (e.g., solder) connection in an embodiment where the antenna feed 14 is a strip line connection.

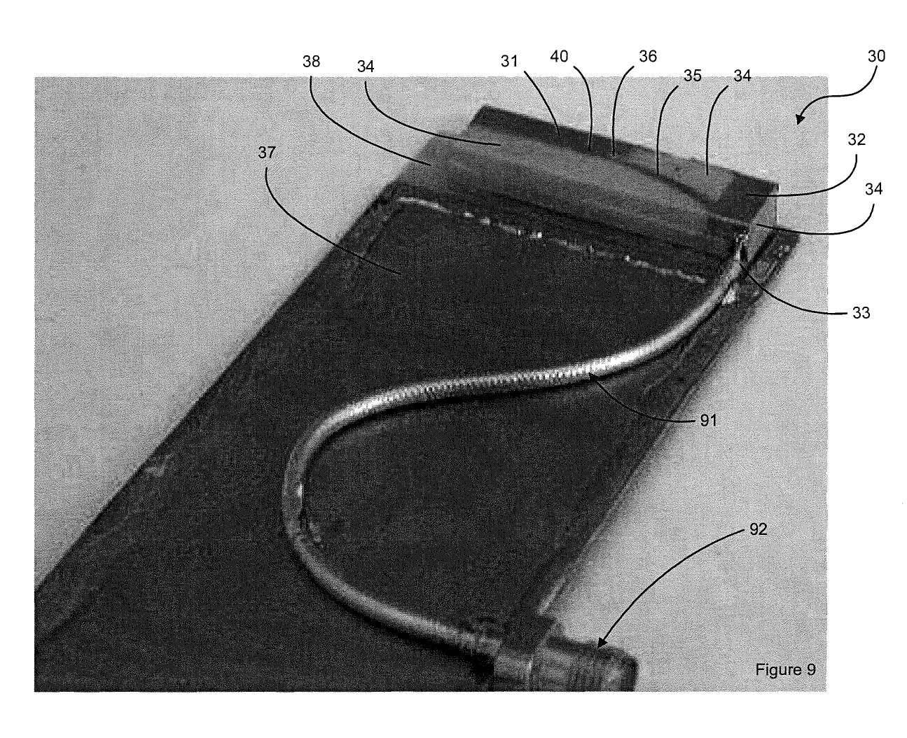

Although described with the antenna feed 14 being a strip feed, the invention is not intended to be so limited. Rather, the antenna feed 14 may be a coaxial cable that feeds the signal to the antenna port 13. An example of such is shown and described in FIG. 9. In this regard, the connector 25 may have a coaxial coupling, such as a SubMiniature version A (SMA) connector, and the antenna port 13 may be similarly configured.

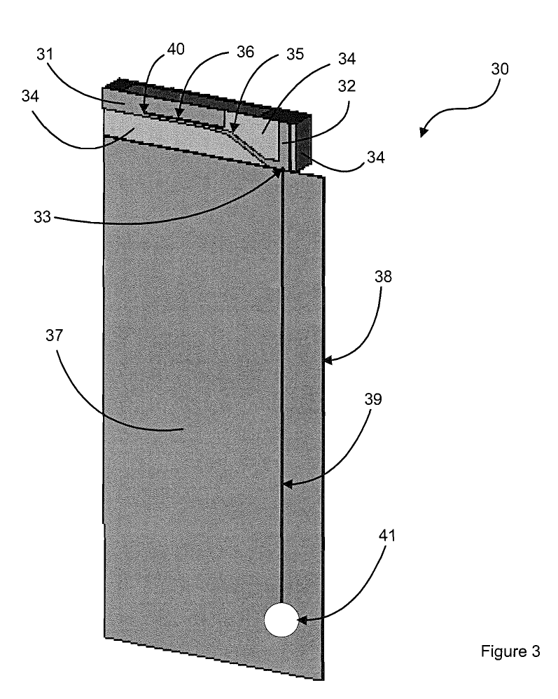

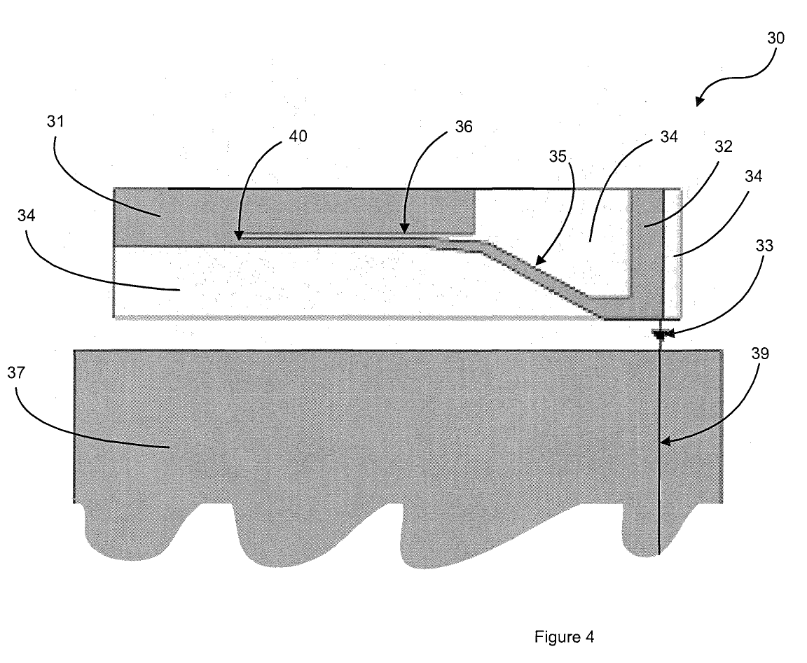

FIG. 3 is a perspective view of one exemplary embodiment of a dielectric based antenna 30 that may provide for a relatively wide range of communication types and/or frequencies. FIG. 4 illustrates an exploded partial view of the dielectric based antenna 30. For example, the dielectric based antenna 30 includes two antenna elements 31 and 32 configured of a conductive material (e.g., copper, aluminum, etc.) wrapped about a ceramic element 34. In this embodiment, the antenna element 31 covers a larger surface area than the antenna element 32. In this regard, the antenna elements 31 and 32 may take advantage of certain antenna length/frequency capability features to provide specialized coverage of frequency bands. That is, the larger antenna element 31 may provide for transmission/reception of lower frequency signals whereas the smaller antenna element 32 may provide for transmission/reception of higher frequency signals. The ceramic element 34 may have a relatively high permittivity that modifies the resonant properties of the antenna elements 31 and 32 (e.g., via dielectric loading as described hereinabove) to enhance the transmission/reception capabilities of the antenna elements 31 and 32 (e.g., by smoothing and/or shaping pass bands).

The antenna elements 31 and 32 may be configured of the same material. For example, the antenna elements 31 and 32 may be “cut” from a single piece of copper foil. In this regard, the two antenna elements 31 and 32 may be connected with a strip feed 35. Accordingly, the two antenna elements 31 and 32 are, in combination, one antenna that provides two different frequency ranges of reception and/or transmission. However, the antenna elements could be configured from two separate pieces of conductive material, either of the same material or of different materials (e.g., copper for antenna element 31 and aluminum for antenna element 32). Such may be done to alter frequency characteristics of the dielectric based antenna 30.

In one embodiment, the antenna element 31 and the strip feed 35 are separated by a relatively thin air slot 36. For example, just as the two antenna elements 31 and 32 and the strip feed 35 may be configured from a single piece of material, the thin air slot 36 may be cut out of the material to provide a separation between the antenna element 31 and the strip feed 35. Such an air slot may confine the frequency characteristics of the antenna element 31 to the antenna element. In other words, the thin air slot 36 may prevent the portion of the strip feed 36 that continues into the antenna element 31 (i.e., until the point 40) from becoming an antenna element itself. Accordingly, lower frequency radiation/reception characteristics of the dielectric based antenna 30 may be confined to antenna element 31 (e.g., the lower frequency band antenna element) while higher frequency radiation/reception characteristics of the antenna may be confined to the antenna element 32 (e.g., the higher frequency band antenna element). In this regard, the separate antenna elements may also serve as band limiting features that assist in filtering out noise from frequencies outside the bands of the antenna elements 31 and 32.

Generally, the size and shape of the antenna elements 31 and 32, in combination with the physical properties of the ceramic element 34, advantageously provide an antenna designer with the ability to configure the dielectric based antenna 30 to operate within a variety of frequency ranges. The invention, however, is not intended to be limited to simply the two antenna elements 31 and 32. For example, the dielectric based antenna 30 may include more than two antenna elements that are configured in a manner similar to antenna elements 31 and 32 (e.g., coupled via strip feeds 35 and separated by thin air slots 36) to provide frequency bands as desired.

As with the dielectric based antenna 10, dielectric based antenna 30 is configured on a substrate 38 with a ground plane 37 affixed thereto. The dielectric based antenna 30 also has an antenna feed 39 coupled to antenna feed port 33 and connector 41 for transferring a signal from the connector (e.g., from a device coupled thereto) to the antenna feed port such that the signal may be radiated from the antenna element 31 or the antenna element 32 as determined by the frequency of the signal.

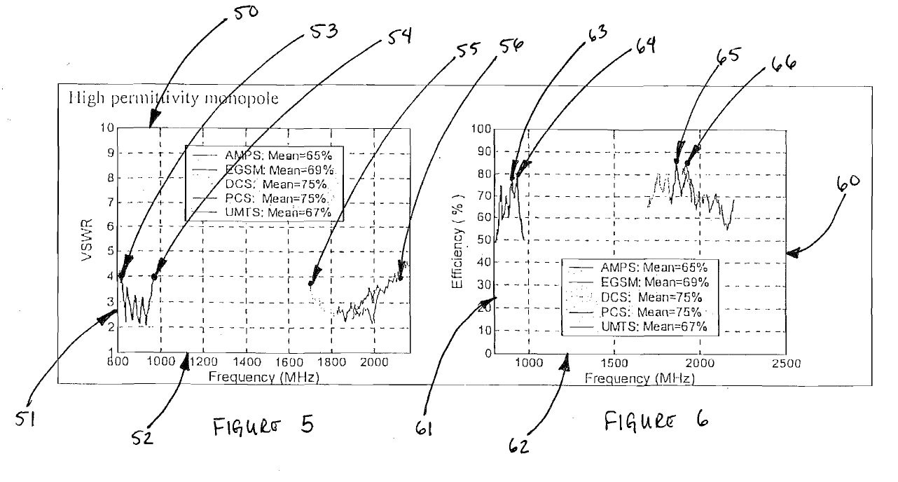

FIGS. 5 and 6 are graphs 50 and 60, respectively, illustrating experimentally obtained frequency characteristics of the dielectric based antenna 30. More specifically, FIG. 5 illustrates the voltage standing wave ratio (axis 51), or VSWR, versus frequency (axis 52) of the dielectric based antenna whereas FIG. 6 illustrates the efficiency (axis 61) of the dielectric based antenna across a frequency spectrum (axis 62). As is well known, a higher VSWR correlates to impedance mismatching and reduced power transfer due to signal reflections along a transmission path (e.g., an antenna). Points 53 and 54, as well as points 55 and 56, on graph 50 illustrate frequencies in the spectrum in which the VSWR begins to increase. Between points 53 and 54 and between points 55 and 56, however, the VSWR is relatively low and is, therefore, capable of efficiently transferring signals.

As discussed above, the shape and size of the antenna elements 31 and 32 of the dielectric based antenna 30 generally assist in the configuration of the frequency bands for the dielectric based antenna. In this regard, the shape and size of the antenna element 31 has enabled a lower frequency band of roughly between 800 and 975 MHz for the antenna element 31, as illustrated between points 53 and 54 of graph 50. The highest efficiencies for this lower frequency band are visible at points 63 and 64 on graph 60. Here, almost 75% of the signal is transferred at roughly between 800 MHz and 950 MHz. Similarly, the shape and size of the antenna element 32 has enabled a higher frequency band of roughly between 1700 and 2200 MHz for the antenna element 32, as illustrated between points 55 and 56 of graph 50. Here, over 80% of the signal is transferred at roughly between 1800 MHz and 1900 MHz, as illustrated by points 65 and 66 on graph 60. In this regard, the antenna element 31 may provide adequate reception and/or transmission for GSM850 and EGSM900 communication signals while the antenna element 32 may provide adequate reception and/or transmission for DCS1800, PCS1900, and UMTS communications signals.

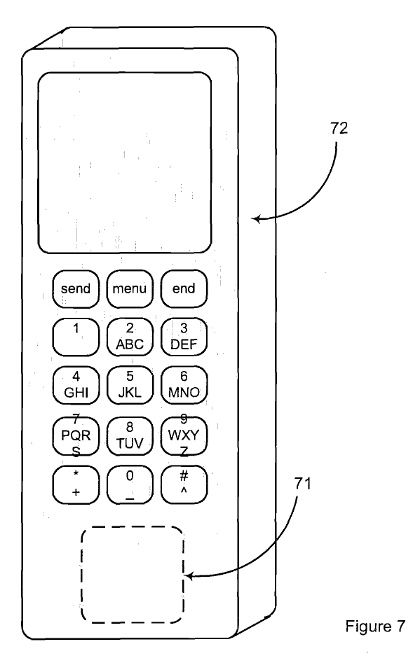

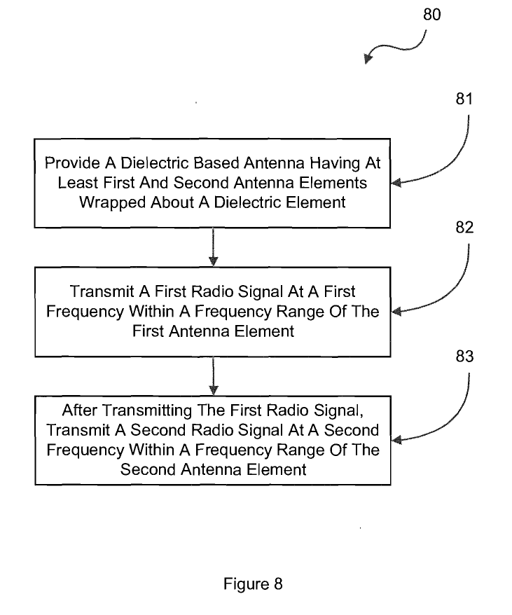

While beneficial for providing reception and/or transmission coverage for the above-mentioned signals, these frequency bands may also serve to limit noise and other interference (e.g., between points 54 and 55 on graph 50) from disrupting the reception and/or transmission of the signals. That is, between the points 54 and 55 on the graph 50 (roughly between 975 MHz and 1700 MHz), the VSWR dramatically increases and tends to dampen or filter interference from that region. Accordingly, a wireless device using a dielectric based antenna configured with the antenna elements 31 and 32 as configured would be readily capable of transmitting and/or receiving each of the GSM850, EGSM900, DCS1800, PCS1900, and UMTS communications signals as needed. Such a wireless device would allow a user of the device to seamlessly switch between communication types and, thus, communication providers. For example, a user may have Sprint PCS Communications as a service provider for the user's mobile phone. Accordingly, the mobile phone may use PCS 1900 communications when operating within the Sprint PCS network. When the user ventures out of the Sprint PCS network (e.g., roams), communications may still be maintained with the user's mobile phone via another communication provider using, e.g., GSM 850. An example of such a mobile phone is shown in FIG. 7 with operational features of a dielectric based antenna being shown in FIG. 8.

In FIG. 7, a mobile phone 72 is illustrated with a dielectric based antenna module 71 shown in phantom. In this regard, the dielectric based antenna module 71 may be configured with a printed circuit board contained within the mobile phone 72. For example, the mobile phone 72, as is typical, has a variety of electronic components that provide the phone's functionality, such as the generation, transmission, and reception, of radio signals. These components may be configured on the printed circuit board along with the dielectric based antenna module 71 in a manner similar to that described hereinabove (e.g., dielectric based antenna 10 of FIG. 2). Accordingly, the printed circuit board, the components affixed thereto, and the dielectric based antenna module 71 may be configured within the mobile phone 72.

FIG. 8 is a flowchart of a process 80 for transmitting signals using a dielectric based antenna, such as dielectric based antenna 30. In process element 81, a dielectric based antenna having at least first and second antenna elements wrapped about a dielectric element is provided such that communications may be established within two distinct frequency bands. In this regard, a first radio signal at a first frequency may be transmitted within a frequency range of the first antenna element, in process element 82. For example, a mobile phone may transmit a GSM signal at about 850 MHz (e.g., within the roughly 800 MHz to 975 MHz frequency band of the antenna element 31) via the antenna element 31 of the co-located dielectric based antenna 30. Sometime thereafter, the mobile phone may switch to a new communication type/frequency band, such as when switching communication providers. In this regard, a second radio signal may be transmitted at a second frequency within a frequency range of the second antenna element, in process element 83. For example, after operating within the GSM network, the mobile phone may roam (e.g., out of country) into a UMTS network where communications can be established around 2100 MHz. The mobile phone may, therefore, switch communication types and begin transmitting UMTS signals at 2100 MHz (e.g., within the roughly 1700 MHz to 2200 MHz band of the antenna element 32).

Although shown and described with respect to the first signal being a GSM 850 communication signal and the second signal being a UMTS communications signal, those skilled in the art should readily recognize that the order of signal transmission is not relevant. Moreover, those skilled in the art should readily recognize that the process 80 of the dielectric based antenna is not intended to be limited to any particular communication type or frequency range. Rather, the process 80 is merely intended to illustrate one exemplary embodiment in which a dielectric based antenna may perform. In this regard, the invention should not be limited to merely mobile phone embodiments. Other devices, such as PDAs and wireless routers, may also take advantage of the frequency/communication options provided by a dielectric based antenna as described herein.

FIG. 9 is a perspective view of the dielectric based antenna 30 configured with a coaxial cable 91. In this embodiment, the coaxial cable 91 is shielded and insulated such that the ground plane 37 does not interfere with communications propagating therethrough. The coaxial cable 91 is coupled to SMA connector 92 to receive various communications signals. A coaxial cable 91 is also coupled to the dielectric based antenna 30 at antenna feed port 33 by means of a galvanic connection. For example, the antenna feed port 33 may be a solder connection between the coaxial cable 91 and a portion of the antenna element 32. In this regard, the signal propagating through the coaxial cable 91 may excite the conductive material that forms the antenna elements 31 and 32. Based on the frequency of propagation, the signal may “channel” to one antenna element or the other. For example, a signal with a lower frequency may pass through the antenna port 33. Since the higher frequency range of the antenna element 32 would essentially band limit the signal, the signal would propagate through the strip feed 35 to the antenna element 31, thereby exciting the antenna element 31 and transmitting a signal therefrom. Similarly, a higher frequency signal would propagate through the antenna port 33 and excite the antenna element 32 while being been limited by the antenna element 31.

It should be understood that the particular antenna element configurations (e.g., shapes of the dielectric element and/or antenna elements, the number of antenna elements, etc.) described herein could be varied to achieve the same or similar objectives. In this regard, the embodiments given herein are merely exemplary. Other embodiments may have fewer or more antenna elements than shown and described herein to provide differing frequency bands for the dielectric based antenna.

The foregoing description has been presented for purposes of illustration and description. Furthermore, the description is not intended to limit the invention to the form disclosed herein. While a number of exemplary aspects and embodiments have been discussed above, those of skill in the art will recognize certain variations, modifications, permutations, additions, and sub-combinations thereof. It is therefore intended that the following appended claims and claims hereafter introduced are interpreted to include all such variations, modifications, permutations, additions, and sub-combinations as are within their true spirit and scope.

What is claimed is:

1. A wireless communication device, including:
a dielectric based antenna that includes a dielectric element and at least first and second antenna elements, wherein the first and second antenna elements are respectively wrapped about first and second portions of the dielectric element;
an antenna feed coupled to the dielectric based antenna; and
a communication module coupled to the antenna feed.

2. The wireless communication device of claim 1, wherein the first antenna element has a surface area that is greater than the surface area of the second antenna element.

3. The wireless communication device of claim 2, wherein the antenna feed is galvanically coupled to the second antenna element.

4. The wireless communication device of claim 2, wherein the first antenna element is coupled to the second antenna element via a strip feed.

5. The wireless communication device of claim 4, wherein the first antenna element, the second antenna element, and the strip feed are configured from substantially the same conductive material.

6. The wireless communication device of claim 4, wherein the first antenna element, the second antenna element, and the strip feed are configured from a single conductive material.

7. The wireless communication device of claim 1, wherein the dielectric element includes an aperture that provides an air slot between the first and second antenna elements.

8. The wireless communication device of claim 1, further comprising an antenna feed port configured proximate to the second antenna element for providing a coaxial coupling to the antenna feed, wherein the antenna feed is a coaxial cable.

9. The wireless communication device of claim 1, further comprising an antenna feed port configured proximate to the second antenna element for providing a galvanic coupling to the antenna feed, wherein the antenna feed is a conductive strip.

10. The wireless communication device of claim 1, wherein the communication module is a receiver, transmitter, or a transceiver.

11. The wireless communication device of claim 1, wherein the dielectric element includes a material having a high permittivity.

12. The wireless communication device of claim 1, wherein the dielectric based antenna is either a monopole antenna or a dipole antenna.

13. The wireless communication device of claim 1, wherein the dielectric based antenna is operable with a range of radio frequencies from about 800 MHz to about 2200 MHz.

14. The wireless communication device of claim 1, wherein the dielectric based antenna is operable with one or more communication signal types selected from a group consisting of GSM 850, EGSM 900, DCS 1800, PCS 1900, and UMTS.

15. The wireless communication device of claim 1, wherein the dielectric based antenna is operable with at least the following communication signal types: GSM 850, EGSM 900, DCS 1800, PCS 1900, and UMTS.

16. A dielectric based antenna, including:
a dielectric element;
a conductive antenna element wrapped about at least a portion of the dielectric element; and
an antenna feed port galvanically coupled to the conductive antenna element.

17. A dielectric based antenna, including:
a substrate;
a ground plane affixed to a first layer of the substrate;
a dielectric element having a first permittivity and a surface, wherein the dielectric element is mounted on the first layer of a substrate proximate to the ground plane;
an antenna module affixed to at least a portion of the surface of the dielectric element; and
an antenna feed coupled to the antenna module.

18. The dielectric based antenna of claim 17, wherein the antenna element is configured for operation with a wide band of radio frequencies.

19. The dielectric based antenna of claim 18, wherein the antenna module includes a first antenna element that transmits radio signals within a first band of radio frequencies within the wide band of radio frequencies.

20. The dielectric based antenna of claim 19, wherein the antenna module includes a second antenna element that transmits radio signals within a second band of radio frequencies within the wideband of radio frequencies, wherein the second band of radio frequencies is higher than the first band of radio frequencies.

21. The dielectric based antenna of claim 20, wherein the first antenna element is affixed to a first portion of the surface of the dielectric element and the second antenna element is affixed to a second portion of the surface of the dielectric element.

22. The dielectric based antenna of claim 19, wherein the antenna element includes an air slot configured between the first antenna element and the second antenna element.

23. The dielectric based antenna of claim 19, wherein the antenna element includes a conductive strip coupling the first antenna element in the second antenna element.

24. The dielectric based antenna of claim 19, wherein the wideband of radio frequencies includes a range from about 800 MHz to about 2200 MHz.

25. The dielectric based antenna of claim 17, wherein the antenna module is operable with one or more communication signal types selected from a group consisting of GSM 850, EGSM 900, DCS 1800, PCS 1900, and UMTS.

26. The dielectric based antenna of claim 17, wherein the antenna module is operable with at least the following communication signal types: GSM 850, EGSM 900, DCS 1800, PCS 1900, and UMTS.

27. The dielectric based antenna of claim 17, wherein the dielectric element is configured from a ceramic material having a high permittivity.

28. The dielectric based antenna of claim 17, wherein the antenna module includes at least a first antenna element and a second antenna element and wherein the dielectric based antenna further includes an antenna feed port galvanically coupled to the second antenna element.

29. The dielectric based antenna of claim 28, wherein the antenna feed is a coaxial cable that couples to the antenna feed port.

30. The dielectric based antenna of claim 28, wherein the antenna feed is a conductive strip that galvanically couples to the antenna feed port.

31. A method of transmitting radio signals, including:
providing a dielectric based antenna having a first antenna element and a second antenna element wrapped about a dielectric element that configures a frequency range of operability for the dielectric based antenna;
transmitting a first radio signal at a first frequency within the frequency range of operability; and
after transmitting the first radio signal at the first frequency, transmitting a second radio signal at a second frequency within the frequency range of operability, wherein the first frequency differs from the second frequency.

32. The method of claim 31, wherein the first and second radio signals are selected from a group consisting of GSM 850, EGSM 900, DCS 1800, PCS 1900, and UMTS.
